(19) United States
(12) Patent Application Publication
(10) Pub. No.: US 2013/0132369 A1
(43) Pub. Date: May 23, 2013

(54) BATCHED SHORTEST PATH COMPUTATION

(71) Applicants: Daniel Delling, Mountain View, CA (US); Andrew V. Goldberg, Redwood City, CA (US); Renato F. Werneck, San Francisco, CA (US)

(72) Inventors: Daniel Delling, Mountain View, CA (US); Andrew V. Goldberg, Redwood City, CA (US); Renato F. Werneck, San Francisco, CA (US)

(73) Assignee: Microsoft Corporation, Redmond, WA (US)

(21) Appl. No.: 13/298,297

(22) Filed: Nov. 17, 2011

(51) Int. Cl. G06F 17/30

(52) U.S. Cl. 707/716; 707/E17.131

(57) ABSTRACT

A batched shortest path problem, such as a one-to-many problem, is solved on a graph by using a preprocessing phase, a target selection phase, and then, in a query phase, computing the distances from a given source in the graph with a linear sweep over all the vertices. Contraction hierarchies may be used in the preprocessing phase and in the query phase. Optimizations may include reordering the vertices in advance to exploit locality and using parallelism.

### BACKGROUND

Existing computer programs known as road-mapping programs provide digital maps, often complete with detailed road networks down to the city-street level. Typically, a user can input a location and the road-mapping program will display an on-screen map of the selected location. Some road-mapping products include the ability to calculate a best route between two locations. The user can input two locations, and the road-mapping program will compute the driving directions from the source location to the destination location.

The computation of driving directions can be modeled as finding the shortest path on a graph which may represent a road map or network. Given a source (the origin) and a target (the destination), the goal is to find the shortest (least costly) path from the source to the target. Existing road-mapping programs employ variants of a method attributed to Dijkstra to compute shortest paths. Dijkstra's algorithm, which is well known, is the standard solution to this problem. It processes vertices one by one, in order of increasing distance from the source, until the destination is reached.

Thus, motivated by web-based map services and autonomous navigation systems, the problem of finding shortest paths in road maps and networks has received a great deal of attention recently. However, research has focused on accelerating point-to-point queries, in which both a source and a target are known, as opposed to other optimization problems that involve determining distances between batches or sets of vertices, such as the one-to-many problem (e.g., given a set of targets, compute the distances between a source and all vertices in the set of targets). Dijkstra's algorithm may be used in solving the one-to-many problem. However, current solutions to the one-to-many problem on large networks, such as on the road networks of Europe or North America, are inefficient.

### SUMMARY

Batched shortest path problems, such as the one-to-many problem, may be solved on a graph using three phases: a preprocessing phase, a target selection phase, and a query phase. After preprocessing and a target selection phase, one-to-many queries can be answered.

In an implementation, the preprocessing technique applies contraction hierarchy (CH) preprocessing to compute vertex ranks and levels. Vertices then are reordered according to the levels. For a given set of targets, the target selection technique extracts parts of the hierarchy in order to accelerate the computation of the distances to all vertices in the set of targets. The query consists of a forward CH search followed by a pass over the vertices in the extracted graph in the precomputed order.

In an implementation, the technique can be used to answer many-to-many queries. In implementations directed to one-to-many query computations or many-to-many query computations, optimizations may include reordering the vertices in advance to exploit locality and using parallelism at instruction and multi-core level.

This summary is provided to introduce a selection of concepts in a simplified form that are further described below in the detailed description. This summary is not intended to identify key features or essential features of the claimed subject matter, nor is it intended to be used to limit the scope of the claimed subject matter.

### BRIEF DESCRIPTION OF THE DRAWINGS

The foregoing summary, as well as the following detailed description of illustrative embodiments, is better understood when read in conjunction with the appended drawings. For the purpose of illustrating the embodiments, there are shown in the drawings example constructions of the embodiments; however, the embodiments are not limited to the specific methods and instrumentalities disclosed. In the drawings:

FIG. 1 shows an example of a computing environment in which aspects and embodiments may be potentially exploited;

FIG. 2 is an operational flow of an implementation of a method which may be used in solving a batched shortest path problem, such as a one-to-many problem;

FIG. 3 is an operational flow of an implementation of a preprocessing method which may be used in solving a batched shortest path problem, such as a one-to-many problem;

FIG. 4 is an operational flow of an implementation of a target selection method;

FIG. 5 is an operational flow of an implementation of a method which may be used at query time in solving a batched shortest path problem, such as a one-to-many problem;

FIG. 6 is an operational flow of an implementation of a method of retrieving full shortest paths;

FIG. 7 is an operational flow of an implementation of a method for reordering vertices; and

FIG. 8 shows an exemplary computing environment.

### DETAILED DESCRIPTION

Batched shortest path problems, such as the one-to-many problem, have many applications in map services, such as prediction of driving trajectories, mobile opportunistic planning, ride sharing, and map matching, for example. As an example, the one-to-many problem appears in algorithms to predict the trajectory of drivers using GPS locations. A probability distribution is maintained over all possible destinations (typically any intersection within a metropolitan area). As the vehicle moves, the distribution is updated accordingly. This is done under the assumption that, whatever the destination is, the driver wants to get there quickly along a shortest path. Updating the probabilities uses computing shortest paths from the current location to all candidate destinations.

One-to-many shortest paths may also be used in mobile opportunistic planning. At any point during a planned trip from a source to a target, the system evaluates a set of potential intermediate goals (waypoints such as gas stations, coffee shops, or grocery stores, for example) that may be suggested to the driver. Deciding which waypoint to present depends on several factors, including the length of the modified route: a comparison may be made between the original route to the target, and the route that passes through the waypoint. This can be determined with two one-to-many computations, from the source to the waypoints and from the target to the waypoints (in the reverse graph).

A related application is ride sharing. Here, one is given a set of offers (s,t), i.e., people driving from the source s to the target t who are willing to offer rides. When somebody searches for a ride from s′ to t′, it should be matched to the offer that uses the smallest detour. Thinking of the s′-t′ path as a waypoint, one can solve this problem with one point-to-point and two one-to-many queries.

One-to-many queries also appear in some map matching algorithms. In such a case, one finds paths between clouds of points, each representing one (imprecise) GPS or cell tower reading. Assuming drivers drive efficiently, one can infer the most likely locations of a user by performing a series of shortest path computations between candidate points.

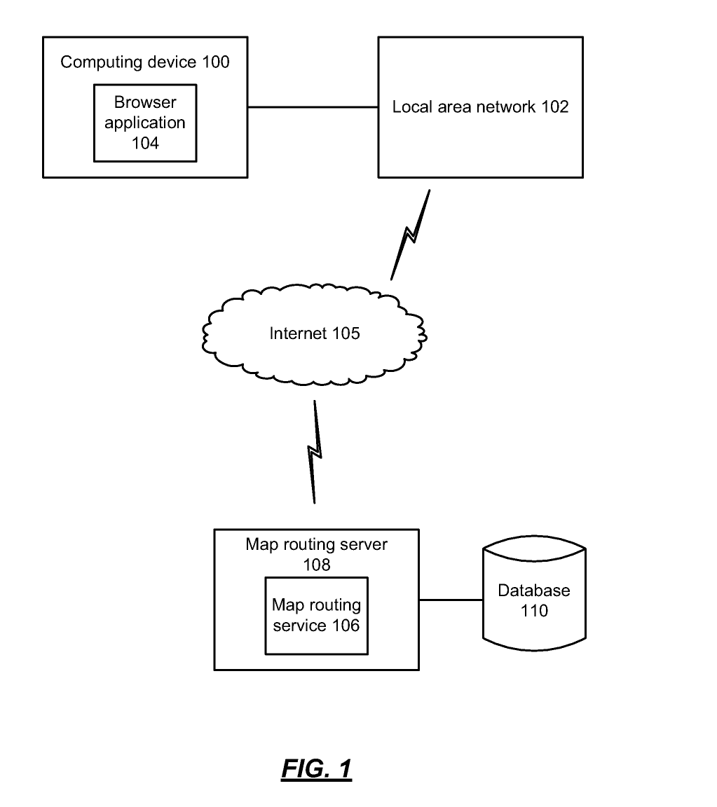

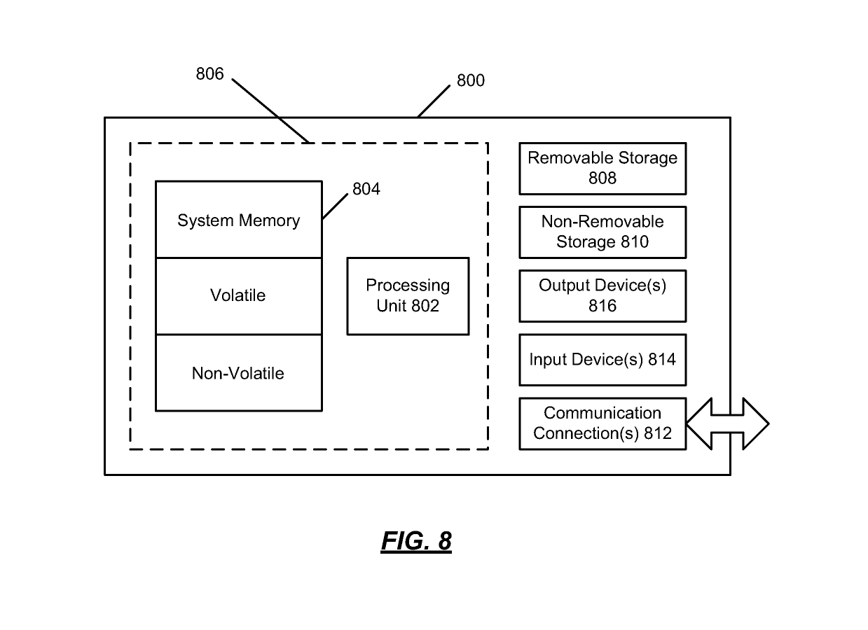

FIG. 1 shows an example of a computing environment in which aspects and embodiments may be potentially exploited. A computing device 100 includes a network interface card (not specifically shown) facilitating communications over a communications medium. Example computing devices include personal computers (PCs), mobile communication devices, etc. In some implementations, the computing device 100 may include a desktop personal computer, workstation, laptop, PDA (personal digital assistant), smart phone, cell phone, or any WAP-enabled device or any other computing device capable of interfacing directly or indirectly with a network. An example computing device 100 is described with respect to the computing device 800 of FIG. 8, for example.

The computing device 100 may communicate with a local area network 102 via a physical connection. Alternatively, the computing device 100 may communicate with the local area network 102 via a wireless wide area network or wireless local area network media, or via other communications media. Although shown as a local area network 102, the network may be a variety of network types including the public switched telephone network (PSTN), a cellular telephone network (e.g., 3G, 4G, CDMA, etc), and a packet switched network (e.g., the Internet). Any type of network and/or network interface may be used for the network.

The user of the computing device 100, as a result of the supported network medium, is able to access network resources, typically through the use of a browser application 104 running on the computing device 100. The browser application 104 facilitates communication with a remote network over, for example, the Internet 105. One exemplary network resource is a map routing service 106, running on a map routing server 108. The map routing server 108 hosts a database 110 of physical locations and street addresses, along with routing information such as adjacencies, distances, speed limits, and other relationships between the stored locations.

A user of the computing device 100 typically enters a query request through the browser application 104. The query request may include a start location (and/or other location, like a destination location, and/or other information like a request for a particular type of establishment like restaurants or pharmacies, for example). The map routing server 108 receives the request and produces output data (e.g., various routes, attractions, data items, locations, identifiers of nearby establishments like restaurants or pharmacies, etc.) among the locations stored in the database 110 with respect to the start location. The map routing server 108 then sends the output data back to the requesting computing device 100. Alternatively, the map routing service 106 is hosted on the computing device 100, and the computing device 100 need not communicate with a local area network 102.

To visualize and implement routing methods, it is helpful to represent locations and connecting segments as an abstract graph with vertices and directed edges. Vertices correspond to locations, and edges correspond to road segments between locations. The edges may be weighted according to the travel distance, transit time, and/or other criteria about the corresponding road segment. The general terms “length” and “distance” are used in context to encompass the metric by which an edge's weight or cost is measured. The length or distance of a path is the sum of the weights of the edges contained in the path. For manipulation by computing devices, graphs may be stored in a contiguous block of computer memory as a collection of records, each record representing a single graph node or edge along with associated data.

As described further herein, the map routing service 106 can efficiently determine batched shortest paths on networks such as road networks. Examples of batched shortest paths include solutions to one-to-many queries (computing paths from a single source to multiple targets) and many-to-many queries (computing paths from multiple sources to multiple targets). More particularly, with respect to the one-to-many shortest path problem on road networks, given a graph G with non-negative arc lengths and a source s, the distance is determined from the source s to a preselected set of targets T in the graph G. The techniques herein can be extended to solve the many-to-many shortest path problem in which all distances are determined between two vertex sets S and T in the graph G.

A road network may be viewed as a graph G=(V,A), where vertices represent intersections and arcs represent road segments. Each arc (v,w) εA has a nonnegative length l(v,w) representing the time to travel along the corresponding road segment. The many-to-many shortest path problem takes as input the graph G, a nonempty set of sources S⊂V, and a nonempty set of targets T⊂V. Its output is an |S|×|T| table containing the distances dist(s,t) from each source sεS to each target tεT. The point-to-point shortest path problem has a single source s (S={s}) and a single target t (T={t}). The one-to-many problem has a single source s, but multiple targets (|T|≧1). The one-to-all problem computes the distances from a single source to all vertices in the graph (S={s}, T=V).

The standard approach to computing shortest paths on networks with nonnegative lengths is the well known Dijkstra's algorithm. For every vertex v, it maintains the length d(v) of the shortest path from the source s to v found so far, as well as the predecessor (parent) p(v) of v on the path. Initially, d(s)=0, d(v)=∞ for all other vertices, and p(v)=null for all v. The technique maintains a priority queue of unscanned vertices with finite d values. At each step, it removes from the queue a vertex v with minimum d(v) value and scans it: for every arc (v,w) εA with d(v)+l(v,w)<d(w), it sets d(w)=d(v)+l(v,w) and p(w)=v. The technique terminates when the queue becomes empty.

For point-to-point or one-to-many queries, Dijkstra's algorithm can stop as soon as all targets in T are scanned. This can make it much faster when s and T are confined to a small region, but will not increase the speed much if s is very far from even a single element in T.

For point-to-point queries in road networks, several techniques can be much faster than Dijkstra's technique. Such techniques work in two phases: a preprocessing phase and a query phase. The preprocessing phase, which is run offline (before queries are known), takes the graph as input and computes some auxiliary data. The query phase takes the source s and the target t as inputs, and uses the auxiliary data to speed up the computation of the shortest s-t path.

One such well known two phase technique that has been used to speed up point-to-point shortest path computations on road networks is contraction hierarchies (CH). The first phase of CH sorts the vertices by importance (heuristically), then shortcuts them in this order. To shortcut a vertex, the vertex is temporarily removed from the graph and as few new edges as needed are added to preserve distances between all remaining (more important) vertices.

The shortcut operation deletes a vertex v from the graph (temporarily) and adds arcs between its neighbors to maintain the shortest path information. More precisely, for any pair of vertices {u,w} that are neighbors of vertex v such that (u,v)•(v,w) is the only shortest path in between vertex u and vertex w in the current graph, a shortcut (u,w) is added with l(u,w)=l(u,v)+l(v,w). The output of this routine is the set A⁺ of shortcut arcs and the position of each vertex v in the order (denoted by rank(v)).

The second phase (i.e., the query phase) of CH runs a bidirectional version of Dijkstra's algorithm on the graph G⁺ (where G⁺=(V, A∪A⁺), with both searches only looking at arcs that lead to neighbors with higher rank. As used herein, G↑ refers to the graph containing only upward arcs and G↓ refers to the graph containing only downward arcs, where G↑=(V, A↑) and G↓=(V, A↓). Accordingly, G↑ may be defined=(V, A↑) by A↑={(v,w)εA∪A⁺: rank(v)<rank(w)}. Similarly, A↓ may be defined={(v,w)εA∪A⁺: rank(v)>rank(w)} and G↓ defined=(V, A∪A↓).

During an s-t query, the forward CH search runs Dijkstra from s in G↑, and the reverse CH search runs reverse Dijkstra from t in G↓. These searches lead to upper bounds dₛ(v) and dₜ(v) on distances from s to v and from v to t for every vεV. For some vertices, these estimates may be greater than the actual distances (and even infinite for unvisited vertices). However, as is known, the maximum-rank vertex u on the shortest s-t path is guaranteed to be visited, and v=u will minimize the distance dₛ(v)+dₜ(v)=dist(s,t).

Hub labels (HL) is a labeling algorithm for the point-to-point problem. During preprocessing, it computes two labels for each vertex vεV. The forward label L_{f}(v) contains tuples (u, d(v,u)) (for several u), while the reverse label Lᵣ(v) contains tuples (w, d(w,v)) (for several w). Here d(x,y) denotes an upper bound on dist(x,y). These labels have the cover property: for any pair s, tεV, there is at least one vertex v (called the hub) in both L_{f}(s) and Lᵣ(t) such that d(s,v)+d(v,t)=dist(s,t). An s-t query consists of traversing the labels and identifying such a vertex.

HL uses CH to compute labels during preprocessing. L_{f}(v) contains all vertices scanned during an upward CH search in G↑ and Lᵣ(v) contains all vertices scanned by an upward CH search in G↓. The cover property follows from the correctness of CH.

Making HL practical on continental road networks would require many optimizations. For example, removing from the labels all vertices whose distance bounds (given by the CH search) are too high reduces the average label size by 80%. One can also use shortest path covers (SPCs) to identify the most important vertices of the graph and improve the CH order. This slows down preprocessing, but reduces the average label size to less than 100.

In the one-to-all problem, the distances are found from a single source s to all other vertices in the graph. For road networks, the well known PHAST technique may be used. Unlike Dijkstra's technique, it works in two phases. Preprocessing is the same as in CH: it defines a total order among the vertices and builds G↑ and G↓. A one-to-all query from s works as follows. During initialization, set d(s)=0 and d(v)=∞ for all other vεV. Then run an upward search from s in G↑ (a forward CH search), updating d(v) for all vertices v scanned. Finally, the scanning phase of the query processes all vertices in G↓ in reverse rank order (from most to least important). To process v, check for each incoming arc (u, v)εA↓ whether d(u)+l(u, v) improves d(v). If it does, update the value. After all updates, d(v) will represent the exact distance from s to v.

As noted above, the one-to-many problem is the problem of computing the distances from a single source s to all vertices in a target set T. In an implementation, a fixed set of targets T is known in advance, and multiple one-to-many queries may be answered for different sources s. Unlike in the many-to-many problem, the sources may be revealed one at a time, and only after the set of targets.

There are several known techniques for solving the one-to-many problem. The map routing service 106 can perform any of these techniques, for example. First, one can perform a single one-to-many query (from s to T) as a series of |T| point-to-point queries. For every target tεT, perform an independent s-t query using HL for example. A second known approach is a special case of many-to-many, and uses a bucket-based algorithm. The target selection phase builds the buckets from the reverse search spaces of all elements in T. The query phase looks at the forward search space from the source s, and processes the appropriate buckets. A third known approach is to consider one-to-many a special case of one-to-all. One can simply run a one-to-all algorithm from the source s to compute the distances to all vertices, then extract only the distances to vertices in T (and discard all others). If the underlying algorithm is Dijkstra's, it can stop as soon as all vertices in T are scanned. These techniques can be inefficient however.

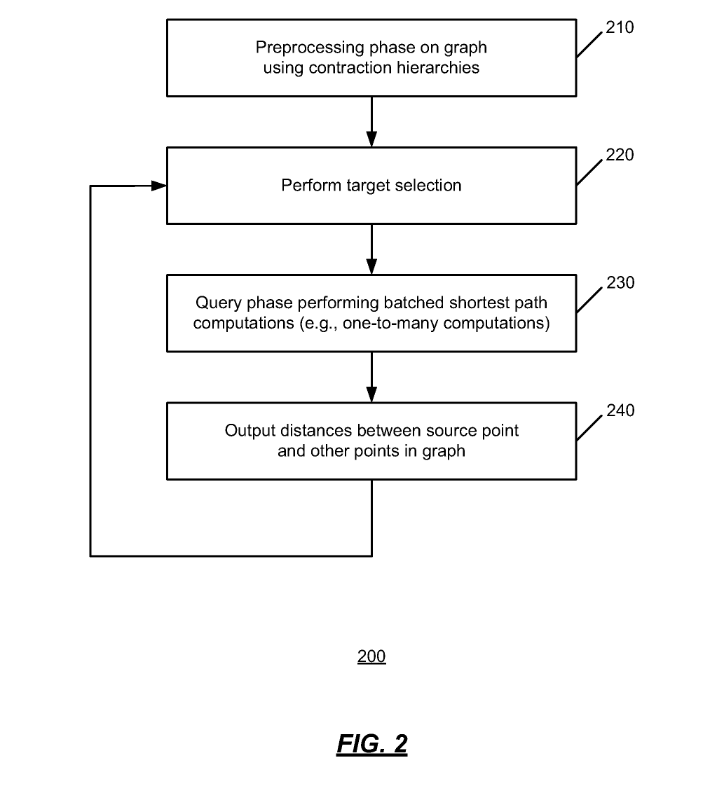

FIG. 2 is an operational flow of an implementation of a method 200 which may be used in solving a batched shortest path problem, such as a one-to-many problem. The method 200 comprises three phases: a preprocessing phase, a target selection phase, and a query phase, and may be performed by the map routing service 106 in an implementation.

At 210, a preprocessing phase is performed on the graph using CH, as described further herein, to generate preprocessed data. In an implementation, the preprocessing phase uses a CH technique along with dividing vertices into levels, assigning new identifiers to vertices and rearranging the vertices. Thus, CH is used to compute vertex ranks and levels. Vertices then are reordered according to the levels.

At 220, target selection is performed. The input to the target selection technique is the preprocessed data from 210 and the given set T. For a given set T, the target selection algorithm extracts parts of the hierarchy in order to accelerate the computation of the distances to all vertices in T. Target selection attempts to extract only the subgraph needed to answer a particular query. The extracted subgraph is referred to as G_{T}.

Upon receiving a query, at 230, a query phase is performed that performs the one-to-many computations, described further herein, with respect to a source location. The input to the query phase is the extracted subgraph G_{T} and the source vertex. The query technique comprises a forward CH search followed by a pass (i.e., a linear sweep) over the vertices in G_{T} in the precomputed order. Note that only the target selection has to be redone when T changes, as shown by the arrow from 240 to 220 in FIG. 2.

The one-to-many computations result in distances between the source vertex and other locations (vertices) in the graph (i.e., the distances (s,t) for all t of T). These distances are outputted, for example, to the computing device 100 (e.g., for display, further processing, and/or storage), at 240.

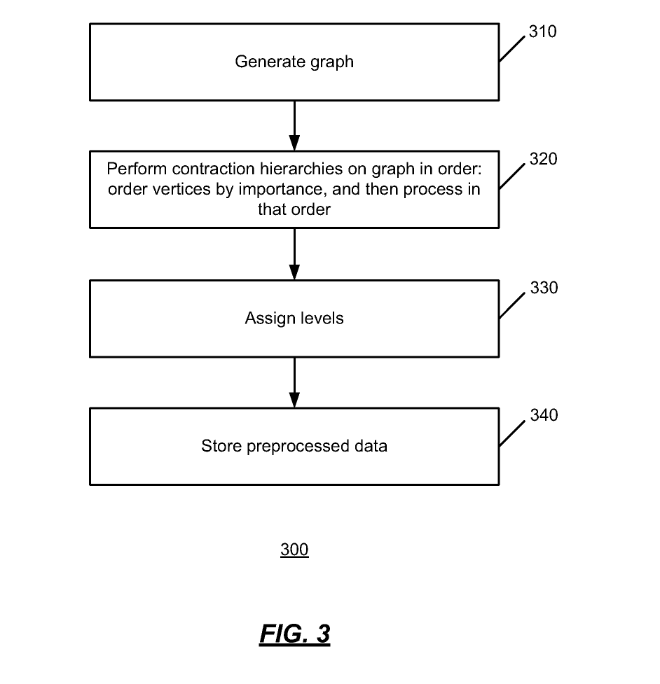

In an implementation, in solving the one-to-many problem, at 210, the preprocessing phase uses the first phase of CH to obtain a set of shortcuts A⁺ and a vertex ordering. FIG. 3 is an operational flow of an implementation of a preprocessing method 300 which may be used in solving a batched shortest path problem, such as a one-to-many problem. At 310, a graph G is generated based on the road network data, map data, or other location data, e.g., stored in the database 110. The graph may be generated by the map routing service 106 or any computing device, such as a computing device 800 described with respect to FIG. 8, for example. Each node of the graph corresponds to a vertex (a point on the graph) and weights (e.g., distances) may be assigned to edges between various vertices.

A contraction hierarchies technique is performed on the vertices of the graph in the order, at 320. Along with the contraction hierarchies, the vertices of the graph are ordered. The vertices may be ordered using any ordering technique. In an implementation, the vertices may be ordered numerically, with each vertex being assigned a different number based on a measure of “importance” for example. Shortcuts (additional edges) may be added between various vertices in order to preserve distances between those vertices.

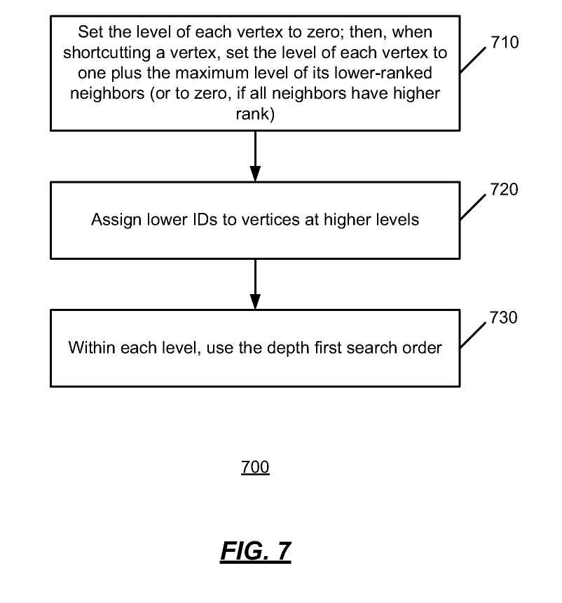

At 330, levels may be assigned to each of the vertices. In an implementation, when assigning levels to vertices, the following constraint is obeyed: for any edge (v,w), if rank(w)>rank(v) then level(w)>level(v). Any number of levels may be used. There is no limit as to the number of vertices that may be assigned to a particular level. In an implementation, levels may be assigned using techniques described with respect to FIG. 7. At 340, the data corresponding to the shortcuts, the levels, the distances between the vertices, and the ordering is stored (e.g., in the database 110) as the preprocessed data. The preprocessed data may then be accessed and used in subsequent target selection (e.g., at 220).

Techniques are described further herein to handle the one-to-many problem efficiently. The techniques are referred to as restricted PHAST (or RPHAST). RPHAST leaves the preprocessing phase unchanged from that set forth above: it assigns ranks to all vertices and builds the upward (G↑) and downward (G↓) graphs. Unlike PHAST, however, RPHAST has a target selection phase (e.g., at 220). Once T is known, it extracts from the contraction hierarchy only the information necessary to compute the distances from any source vertex s to all targets T, creating a restricted downward graph G_{T}↓. RPHAST has the same query phase as PHAST, but uses G_{T}↓ instead of G↓. It still uses G↑ for the forward searches from the source.

To ensure correctness, the graph built by the target selection phase includes the information used to compute paths from any vertex in the graph to any vertex in T. Because the forward search is done on the full graph (G↑), it must only be ensured that G_{T}↓ contains the reverse search spaces of all vertices in T.

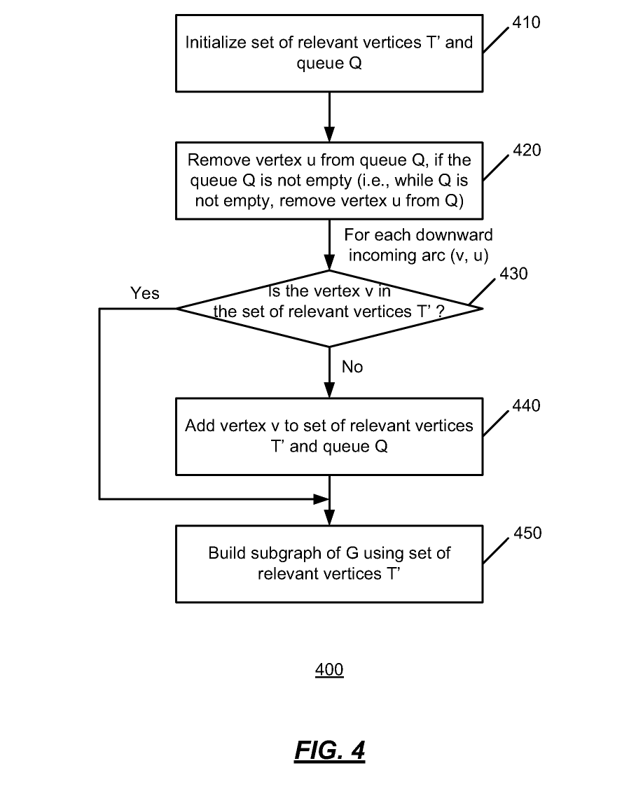

This may be computed by running a separate CH search on G↓ from each vertex in T and marking all vertices visited, but this would be slow. Instead, a single search is performed from all vertices in T at once. FIG. 4 is an operational flow of an implementation of a target selection method 400 which may be used in solving a batched shortest path problem. The target selection method builds a set T′ of relevant vertices. At 410, both T′ and a queue Q are initialized with T. At 420, while Q is not empty, a vertex u is removed from Q and, at 430, it is determined for each downward incoming arc (v, u)εA↓ whether vεT′. If not, v is added to T′ and Q at 440. This process scans only vertices in T′, and each only once. Finally, at 450, G_{T}↓ is built as the subgraph of G↓ induced by T′. In an implementation, whenever the target set T changes, only the target selection phase is rerun, which results in more efficient processing.

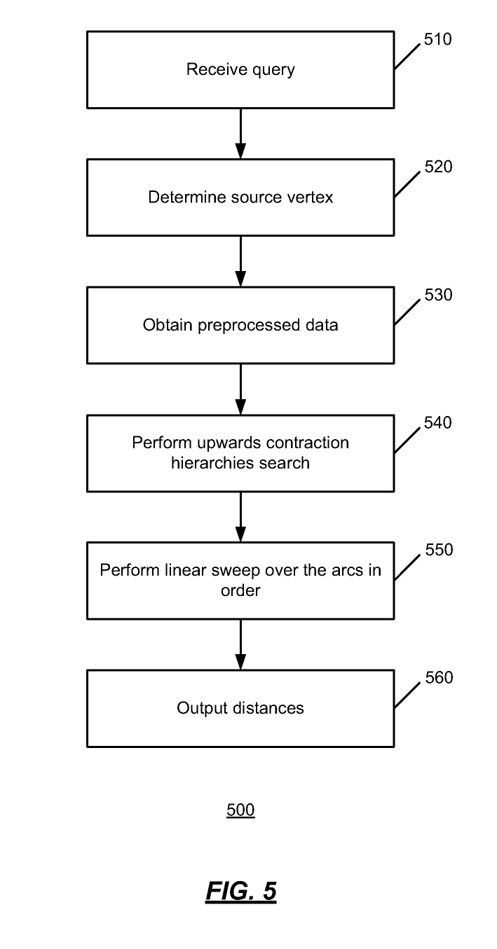

FIG. 5 is an operational flow of an implementation of a method 500 which may be used at query time in solving a batched shortest path problem. At 510, a query is received, e.g. at the map routing service 106 from a user via the computing device 100. The query may be a request for certain locations near (e.g., within a distance from) a source location. For example, the user may request a list of all restaurants near the current location of the user.

At 520, upon receiving the query, a source vertex is determined. The source vertex may be based on the location of the user, the computing device of the user, or on a location provided or selected by the user, for example. The preprocessed data (e.g., from the method 300) is obtained from storage at 530.

At 540, an upwards CH search is performed. In an implementation, for a one-to-many search from the source vertex, a CH forward search from the source vertex is run. At 550, a linear sweep is performed over the arcs (resulting from the CH search) in reverse level order. At 560, the distances that are generated by the linear sweep are output. These distances may be used to respond to the query (e.g., as corresponding to establishments, such as restaurants, that are near the source location).

In an implementation, in solving the one-to-many problem, the query phase initially sets the distance d(v)=∞ for all vertices v that do not equal the source vertex s, and d(s) is set equal to 0. The actual search may be executed in two subphases. First, a forward CH search is performed (at 540): Dijkstra's algorithm is run from the source vertex s in G↑ (in increasing rank order), stopping when the queue of vertices becomes empty. This sets the distance labels d(v) of all vertices visited by the search. The second subphase (at 550) scans all vertices in G_{T}↓ in any reverse topological order (e.g., reverse level order or descending rank order, depending on the implementation). To scan the vertices v, each incoming arc (u, v)εA↓ is examined; if d(v)>d(u)+l(u, v), then d(v) is set equal to d(u)+l(u, v) (otherwise d(v) remains equal to d(v)). This technique is used to set the distances of each of the reached vertices.

The RPHAST techniques described above can be extended to maintain parent pointers, allowing efficient retrieval of actual shortest paths in G⁺. These paths will usually contain shortcuts. If the corresponding original graph edges are needed, well-known path unpacking techniques may be used to expand the shortcuts. Because each shortcut is a concatenation of two arcs (or shortcuts), storing its “middle” vertex during preprocessing is enough to allow fast recursive unpacking during queries.

In certain applications, however, the set S of possible sources is known in advance—for example, when running path prediction algorithms within a single metropolitan area or state. In such cases, RPHAST does not need to keep the entire graph (and all shortcuts) in memory: its target selection phase may be modified to keep only the data needed for unpacking.

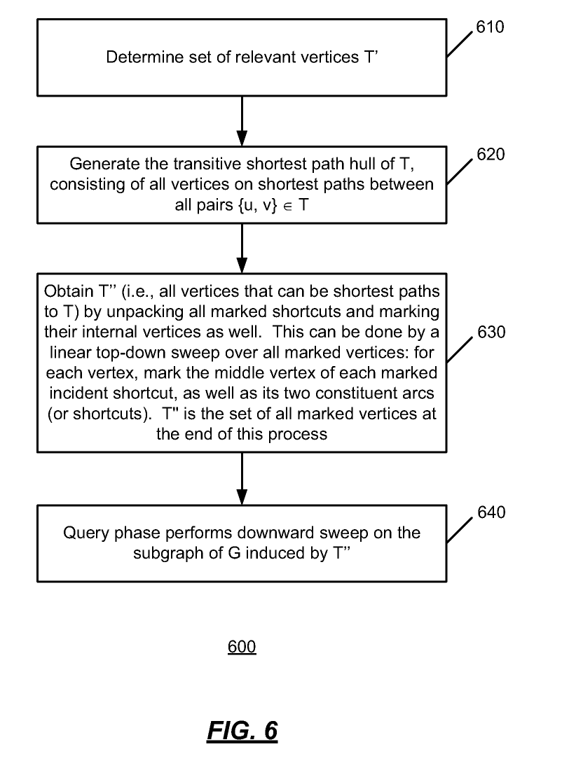

In an implementation, T′ may be extended by all vertices that can be on shortest paths to T. This set is referred to as T″. FIG. 6 is an operational flow of an implementation of a method 600 of retrieving full shortest paths (e.g., in solving a one-to-many problem).

At 610, T′ is computed as in standard RPHAST described above. At 620, the transitive shortest path hull of T is generated, consisting of all vertices on shortest paths between all pairs {u, v}εT. To do so, first identify all boundary vertices B_{T} of T, i.e., all vertices in T with at least one neighbor u∉T in the original graph G. (If a shortest path ever leaves T, it does so through a boundary vertex.) From each bεB_{T}, run an RPHAST query to compute all distances to T. Then mark all vertices and arcs in G↑ and G↓ that lie on a shortest path to any tεT. This procedure marks the shortest path hull in G⁺.

At 630, T″ is obtained by unpacking all marked shortcuts and marking their internal vertices as well. This can be done by a linear top-down sweep over all marked vertices: for each vertex, mark the middle vertex of each marked incident shortcut, as well as its two constituent arcs (or shortcuts). T″ is the set of all marked vertices at the end of this process.

At 640, the query phase performs the downward sweep on G_{T″}↓ (the subgraph of G↓ induced by T″). To query the parent vertex of a vertex uεT″, iterate over all incoming (original) arcs (v,u) and check whether d(v)+l(v,u)=d(u).

In implementations, optimizations may be used to accelerate the processing, and include reordering the vertices in advance to exploit locality and using parallelism at instruction and multi-core level.

FIG. 7 is an operational flow of an implementation of a method 700 for reordering vertices. The method 700 may be performed during preprocessing (at 210), such as while shortcutting the vertices (at 320), for example.

At 710, the level of each vertex is initially set to zero. Then, when shortcutting a vertex u, set L(v)=max{L(v),L(u)+1} for each current neighbor v of u, i.e., for each v such that (u, v)εA↑ or (v, u)εA↓. In this manner, the level of each vertex is set to one plus the maximum level of its lower-ranked neighbors (or to zero, if all neighbors have higher rank). Thus, if (v, w)εA↓, then L(v)>L(w). This means that the query phase can process vertices in descending order of level: vertices on level i are only visited after all vertices on levels greater than i have been processed. This order respects the topological order of G↓.

Within the same level, the vertices can be scanned in any order. In particular, by processing vertices within a level in increasing order of IDs, locality is maintained and the running time of the technique to solve the batched shortest path problem (e.g., one-to-many problem) is decreased.

To increase locality even further, new IDs can be assigned to vertices. At 720, lower IDs are assigned to vertices at higher levels, and at 730, within each level, the depth first search (DFS) order is used. Now the second phase will be correct with a linear sweep in increasing order of IDs. It can access vertices, arcs, and head distance labels sequentially, with perfect locality. The only non-sequential access is to the distance labels of the arc tails (recall that scanning v requires looking at the distance labels of its neighbors). Keeping the DFS relative order within levels helps to reduce the number of the associated cache misses.

Reordering ensures that the only possible non-sequential accesses during the linear sweep phase happen when reading distance labels of arc tails. More precisely, when processing vertex v, look at all incoming arcs (u,v). The arcs themselves are arranged sequentially in memory, but the IDs of their tail vertices are not sequential.

Another optimization is parallelism. Parallelism may be used in an implementation on a multi-core CPU. For computations that use shortest path trees from several sources, different sources may be assigned to each core of the CPU. Since the computations of the trees are independent from one another, speedup is significant. A single tree computation may also be parallelized. For example, vertices of the same level may be processed in parallel if multiple cores are available. In an implementation, vertices in a level may be partitioned into approximately equal-sized blocks and each block is assigned to a thread (i.e., a core). When all the threads terminate, the next level is processed. Blocks and their assignment to threads can be computed during preprocessing. This type of parallelization may be used in a GPU implementation.

In an implementation involving a GPU, the linear sweep of the query phase is performed by the GPU, and the CPU remains responsible for computing the upward CH trees. During initialization, G_{T}↓ and the array of distance labels are copied to the GPU. To compute a tree from a source vertex s, the CH search is run on the CPU and the search space is copied to the GPU. As in the single-tree parallel implementation, each level may be processed in parallel. The CPU starts, for each level i, a kernel on the GPU, which is a collection of threads that all execute the same code and that are scheduled by the GPU hardware. Note that each thread is responsible for exactly one vertex. With this approach, the overall access to the GPU memory is efficient in the sense that memory bandwidth utilization is maximized. If the GPU has enough memory to hold additional distance labels, multiple trees may be computed in parallel.

When computing k trees at once, the CPU first computes the k CH upward trees and copies all k search spaces to the GPU. Again, the CPU activates a GPU kernel for each level. Each thread is still responsible for writing exactly one distance label.

FIG. 8 shows an exemplary computing environment in which example implementations and aspects may be implemented. The computing system environment is only one example of a suitable computing environment and is not intended to suggest any limitation as to the scope of use or functionality.

Numerous other general purpose or special purpose computing system environments or configurations may be used. Examples of well known computing systems, environments, and/or configurations that may be suitable for use include, but are not limited to, PCs, server computers, handheld or laptop devices, multiprocessor systems, microprocessor-based systems, network PCs, minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 8, an exemplary system for implementing aspects described herein includes a computing device, such as computing device 800. In its most basic configuration, computing device 800 typically includes at least one processing unit 802 and memory 804. Depending on the exact configuration and type of computing device, memory 804 may be volatile (such as random access memory (RAM)), non-volatile (such as read-only memory (ROM), flash memory, etc.), or some combination of the two. This most basic configuration is illustrated in FIG. 8 by dashed line 806.

Computing device 800 may have additional features/functionality. For example, computing device 800 may include additional storage (removable and/or non-removable) including, but not limited to, magnetic or optical disks or tape. Such additional storage is illustrated in FIG. 8 by removable storage 808 and non-removable storage 810.

Computing device 800 typically includes a variety of computer readable media. Computer readable media can be any available media that can be accessed by computing device 800 and include both volatile and non-volatile media, and removable and non-removable media.

Computer storage media include volatile and non-volatile, and removable and non-removable media implemented in any method or technology for storage of information such as computer readable instructions, data structures, program modules or other data. Memory 804, removable storage 808, and non-removable storage 810 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 800. Any such computer storage media may be part of computing device 800.

Computing device 800 may contain communication connection(s) 812 that allow the device to communicate with other devices. Computing device 800 may also have input device(s) 814 such as a keyboard, mouse, pen, voice input device, touch input device, etc. Output device(s) 816 such as a display, speakers, printer, etc. may also be included. All these devices are well known in the art and need not be discussed at length here.

It should be understood that the various techniques described herein may be implemented in connection with hardware or software or, where appropriate, with a combination of both. Thus, the processes and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be effected across a plurality of devices. Such devices might include PCs, network servers, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method for graph processing, comprising:
receiving as input, at a computing device, a graph comprising a plurality of vertices and arcs;
performing contraction hierarchies on the graph, by the computing device, to generate shortcuts between at least some of the vertices;
assigning levels to each of the vertices, by the computing device;
generating preprocessed graph data corresponding to the vertices, the shortcuts, and the levels, by the computing device;
performing target selection using the preprocessed graph data and a target set of vertices to generate a subgraph of the graph; and
storing the subgraph of the graph in storage associated with the computing device.

2. The method of claim 1, further comprising ordering the vertices into an order prior to performing the contraction hierarchies on the graph, wherein the contraction hierarchies are performed based on the order, and reordering the vertices after performing the contraction hierarchies on the graph.

3. The method of claim 1, further comprising retrieving full shortest paths for the plurality of vertices.

4. The method of claim 1, wherein performing the target selection comprises performing a single contraction hierarchies search from all vertices in the target set of vertices at once.

5. The method of claim 1, wherein performing the target selection comprises:
for each vertex u in the target set,
determining, for each vertex v in the graph, if each downward incoming arc between the vertex v in the graph and the vertex u is in a set T′ of vertices, and if not, then adding the vertex v to the set T′; and
building the subgraph based on the set T′.

6. The method of claim 5, further comprising extending the set T′ by all vertices that can be on shortest paths to the target set of vertices, to generate a set T″ which enables full shortest path retrieval.

7. The method of claim 6, wherein extending the set T′ to generate the set T″ comprises generating the transitive shortest path hull of the target set of vertices, consisting of all vertices on shortest paths between all pairs {u, v}ε the target set of vertices.

8. The method of claim 1, wherein the graph represents a network of nodes.

9. The method of claim 1, wherein the graph represents a road map.

10. The method of claim 1, wherein the method is implemented for a batched shortest path application.

11. A method for determining distances on a graph, comprising:
preprocessing, at a computing device, a graph comprising a plurality of vertices to generate data corresponding to the vertices, a plurality of shortcuts between at least a portion of the vertices, a plurality of levels associated with the vertices, and an order of the vertices to generate preprocessed graph data;
performing target selection on the preprocessed graph data to generate a subgraph;
receiving a batched shortest path query at the computing device;
determining a source vertex based on the query, by the computing device;
performing, by the computing device, a plurality of batched shortest path computations on the subgraph with respect to the source vertex to determine the distances between the source vertex and a plurality of other vertices in the graph; and
outputting the distances, by the computing device.

12. The method of claim 11, wherein performing the batched shortest path computations comprises:
performing an upwards contraction hierarchies search from the source vertex to determine a plurality of arcs by visiting the plurality of vertices and setting distance estimates of the plurality of vertices; and
performing a linear sweep over the arcs of the subgraph.

13. The method of claim 12, wherein performing the linear sweep comprises scanning the plurality of vertices in a descending rank order.

14. The method of claim 12, wherein the computing device comprises a CPU and a GPU, and the upwards contraction hierarchies search is performed by the CPU and the linear sweep is performed by the GPU.

15. The method of claim 11, wherein the plurality of batched shortest path computations are performed simultaneously.

16. The method of claim 11, wherein the batched shortest path query is a one-to-many query.

17. A method for determining distances on a graph, comprising:
receiving as input, at a computing device, a source vertex and a subgraph of a graph comprising a plurality of vertices, wherein the subgraph is based on preprocessed data corresponding to the vertices, a plurality of shortcuts between at least a portion of the vertices, a plurality of levels associated with the vertices, and an order of the vertices;
performing, by the computing device, a batched shortest path computation on the subgraph with respect to the source vertex to determine the distances between the source vertex and a plurality of other vertices in the graph; and
outputting the distances, by the computing device.

18. The method of claim 17, wherein the preprocessed graph data is generated using contraction hierarchies on the graph, and wherein the batched shortest path computation uses a contraction hierarchies search.

19. The method of claim 17, further comprising generating the preprocessed graph data comprising:
receiving as input the graph comprising the plurality of vertices;
ordering the vertices into an order;
performing the contraction hierarchies on the graph based on the order to generate shortcuts between at least some of the vertices;
assigning levels to each of the vertices; and
storing data corresponding to the vertices, the shortcuts, the order, and the levels, as the preprocessed graph data in storage associated with the computing device.

20. The method of claim 17, further comprising generating the subgraph using target selection, the target selection comprising:
receiving a target set of vertices and the preprocessed data;
for each vertex u in the target set of vertices,
determining, for each vertex v in the graph, if each downward incoming arc between the vertex v in the graph and the vertex u is in a set T′ of vertices, and if not, then adding the vertex v to the set T′; and
building the subgraph based on the set T′.
